(19) United States
(12) Patent Application Publication
(10) Pub. No.: US 2024/0352243 A1
(43) Pub. Date: Oct. 24, 2024

(54) THERMOPLASTIC RESIN COMPOSITION, THERMOPLASTIC RESIN MOLDED ARTICLE, AND PAINTED PART

(71) Applicant: TECHNO-UMG CO., LTD., Tokyo (JP)

(72) Inventors: Hiroki ANDO, Tokyo (JP); Kodai OZAKI, Tokyo (JP)

(21) Appl. No.: 18/712,849

(22) PCT Filed: Mar. 2, 2023
(86) PCT No.: PCT/JP2023/007842

§ 371 Date: May 23, 2024

(30) Foreign Application Priority Data
Mar. 10, 2022 (JP) 2022-037315

(51) Int. Cl. C08L 25/12; C08L 35/06; C08L 51/04

(52) U.S. Cl. CPC C08L 25/12; C08L 35/06; C08L 51/04; C08L 2203/30; C08L 2205/025; C08L 2205/035

(57) ABSTRACT

A thermoplastic resin composition containing: 10 to 50 parts by mass of a rubber-containing graft copolymer (A) obtained by graft polymerizing a vinyl monomer mixture (a2) containing a vinyl cyanide monomer and an aromatic vinyl monomer in the presence of a rubbery polymer (a1); 5 to 90 parts by mass of a vinyl cyanide-maleimide copolymer (B) obtained by copolymerizing 5 to 30% by mass of a vinyl cyanide monomer (b1), 20 to 60% by mass of a maleimide monomer (b2), and 10 to 75% by mass of another vinyl monomer (b3) copolymerizable with these (where a total of (b1), (b2), and (b3) is 100% by mass); and 0 to 45 parts by mass of a vinyl cyanide-aromatic vinyl copolymer (C) obtained by copolymerizing a vinyl monomer mixture (c1) containing a vinyl cyanide monomer and an aromatic vinyl monomer.

### TECHNICAL FIELD

The present invention relates to a thermoplastic resin composition that has excellent heat resistance, impact resistance, and fluidity as moldability, and can provide molded articles having excellent paintability and durability. The present invention also relates to a thermoplastic resin molded article using this thermoplastic resin composition. The present invention also relates to a painted part obtained by coating this thermoplastic resin molded article.

### BACKGROUND ART

Rubber-reinforced styrene resins typified by ABS resins, have excellent impact resistance, mechanical strength, and chemical resistance, so they are used in a wide range of fields, including office-related equipment, information and communication equipment, electronic and electrical equipment, household electrical equipment, interior and exterior parts of automobiles, exterior parts of motorcycles, interior parts of railway vehicles, building materials, and the like.

In particular, for vehicle applications, there is a demand for improved heat resistance and weight reduction, and ABS resin (specific gravity 1.07) having a lower specific gravity than polycarbonate resin (specific gravity 1.14 to 1.17) is expected to be applied. Furthermore, high heat resistance (90° C. or higher), excellent paintability, and high durability (fatigue properties) are also becoming important for vehicle spoilers.

Conventionally, proposals have been made in PTLs 1 and 2 as thermoplastic resin compositions having excellent heat resistance and paintability.

### CITATION LIST

### Patent Literature

PTL 1: JP 2012-36384 A
PTL 2: WO 2018/116850 A

### SUMMARY OF INVENTION

### Technical Problem

PTL 1 discloses a maleimide-based heat-resistant and paint-resistant thermoplastic resin composition. However, the thermoplastic resin composition of PLT 1 has problems such as insufficient paintability (paint surface popping) at areas where stress is applied such as the surface of a molded article; gas generation during molding; and insufficient durability.

PTL 2 discloses a heat-resistant and paint-resistant thermoplastic resin composition containing two or more types of copolymers. The thermoplastic resin composition of PTL 2 also has problems such as insufficient paintability (paint surface popping) at areas where stress is applied such as the surface of a molded article; insufficient heat resistance; and insufficient durability.

An object of the present invention is to provide a thermoplastic resin composition that has excellent heat resistance, impact resistance, and fluidity, and also has excellent paintability and durability of the resulting thermoplastic resin molded article.

### Solution to Problem

The present inventor found that the above-mentioned object can be achieved by a thermoplastic resin composition containing a specific rubber-containing graft copolymer (A), a vinyl cyanide-maleimide copolymer (B), and a vinyl cyanide-aromatic vinyl copolymer (C) at a specific ratio.

The scope of the present invention is as described below.

[1] A thermoplastic resin composition comprising:
10 to 50 parts by mass of a rubber-containing graft copolymer (A) obtained by graft polymerizing a vinyl monomer mixture (a2) containing a vinyl cyanide monomer and an aromatic vinyl monomer in the presence of a rubbery polymer (a1);
5 to 90 parts by mass of a vinyl cyanide-maleimide copolymer (B) obtained by copolymerizing 5 to 30% by mass of a vinyl cyanide monomer (b1), 20 to 60% by mass of a maleimide monomer (b2), and 10 to 75% by mass of another vinyl monomer (b3) copolymerizable with these (where a total of (b1), (b2), and (b3) is 100% by mass); and
0 to 45 parts by mass of a vinyl cyanide-aromatic vinyl copolymer (C) obtained by copolymerizing a vinyl monomer mixture (c1) containing a vinyl cyanide monomer and an aromatic vinyl monomer,
a total of the rubber-containing graft copolymer (A), the vinyl cyanide-maleimide copolymer (B), and the vinyl cyanide-aromatic vinyl copolymer (C) being 100 parts by mass,
wherein the content of the maleimide monomer unit in the thermoplastic resin composition is 10 to 45 parts by mass based on 100 parts by mass of the total of the rubber-containing graft copolymer (A), the vinyl cyanide-maleimide copolymer (B), and the vinyl cyanide-aromatic vinyl copolymer (C).

[2] The thermoplastic resin composition according to [1], further comprising 0.1 to 15 parts by mass of an olefin resin (D) based on 100 parts by mass of the total of the rubber-containing graft copolymer (A), the vinyl cyanide-maleimide copolymer (B), and the vinyl cyanide-aromatic vinyl copolymer (C).

[3] The thermoplastic resin composition according to [1] or [2], further comprising 0.1 to 15 parts by mass of an ethylene-(meth)acrylic acid ester-carbon monoxide copolymer (E) based on 100 parts by mass of the total of the rubber-containing graft copolymer (A), the vinyl cyanide-maleimide copolymer (B), and the vinyl cyanide-aromatic vinyl copolymer (C).

[4] The thermoplastic resin composition according to any one of [1] to [3], wherein the vinyl monomer (b3) is at least one selected from the group consisting of aromatic vinyl monomers, unsaturated carboxylic acid ester monomers, unsaturated dicarboxylic acids, unsaturated dicarboxylic acid anhydrides, and unsaturated amides.

[5] A thermoplastic resin molded article produced by molding the thermoplastic resin composition according to any one of [1] to [4].

[6] A painted part obtained by coating the thermoplastic resin molded article according to [5].

### Advantageous Effects of Invention

According to the present invention, it is possible to provide a thermoplastic resin composition that has excellent heat resistance, impact resistance, and fluidity, and also has excellent paintability and durability of the resulting thermoplastic resin molded article.

Molded article made from the thermoplastic resin composition of the present invention have excellent heat resistance, impact resistance, paintability, and durability, and therefore are suitable for use in a wide range of fields, including office-related equipment, information and communication equipment, electronic and electrical equipment, household electrical equipment, interior and exterior parts of automobiles, exterior parts of motorcycles, interior parts of railway vehicles, building materials, and the like. In particular, the thermoplastic resin molded article of the present invention is suitably used for vehicle applications.

### DESCRIPTION OF EMBODIMENTS

The embodiment according to the present invention will be described below in detail. These descriptions are examples (representative examples) of the embodiments of the present invention, and the present invention is not limited to these contents unless the gist thereof is exceeded.

### [Thermoplastic Resin Composition]

The thermoplastic resin composition according to the present invention is a thermoplastic resin composition composition containing:
10 to 50 parts by mass of a rubber-containing graft copolymer (A) (hereafter sometimes referred to as “component (A)”) obtained by graft polymerizing a vinyl monomer mixture (a2) containing a vinyl cyanide monomer and an aromatic vinyl monomer in the presence of a rubbery polymer (a1);
5 to 90 parts by mass of a vinyl cyanide-maleimide copolymer (B) (hereafter sometimes referred to as “component (B)”) obtained by copolymerizing 5 to 30% by mass of a vinyl cyanide monomer (b1), 20 to 60% by mass of a maleimide monomer (b2), and 10 to 75% by mass of another vinyl monomer (b3) copolymerizable with these (where a total of (b1), (b2), and (b3) is 100% by mass); and
0 to 45 parts by mass of a vinyl cyanide-aromatic vinyl copolymer (C) (hereafter also referred to as “component (C)”) obtained by copolymerizing a vinyl monomer mixture (c1) containing a vinyl cyanide monomer and an aromatic vinyl monomer,
a total of the rubber-containing graft copolymer (A), the vinyl cyanide-maleimide copolymer (B), and the vinyl cyanide-aromatic vinyl copolymer (C) being 100 parts by mass,
wherein the content of the maleimide monomer unit in the thermoplastic resin composition is 10 to 45 parts by mass based on 100 parts by mass of the total of the rubber-containing graft copolymer (A), the vinyl cyanide-maleimide copolymer (B), and the vinyl cyanide-aromatic vinyl copolymer (C).

### [Rubber-Containing Graft Copolymer (A)]

The rubber-containing graft copolymer (A) is obtained by graft polymerizing the vinyl monomer mixture (a2) in the presence of the rubbery polymer (a1).

<Rubbery Polymer (a1)>

There is no particular limitation regarding the rubbery polymer (a1) (hereafter sometimes referred to as “component (a1)”) constituting the rubber-containing graft copolymer (A), but examples thereof include diene-based rubber, acrylic rubber, ethylene-based rubber, and the like. Specific examples include polybutadiene, poly(butadiene-styrene), poly(butadiene-acrylonitrile), polyisoprene, poly(butadiene-butyl acrylate), poly(butadiene-methyl acrylate), polybutyl acrylate, poly(butadiene-methyl methacrylate), poly(butadiene-ethyl acrylate), ethylene-propylene rubber, ethylene-propylene-diene rubber, poly(ethylene-isobutylene), poly(ethylene-methyl acrylate), poly(ethylene-ethyl acrylate), and the like. These rubbery polymers may be used alone or in a mixture of two or more. Among these, polybutadiene, polybutyl acrylate, and poly(butadiene-styrene) (styrene-butadiene copolymer rubber) are preferably used from the viewpoint of improving the impact resistance of the thermoplastic resin composition of the present invention.

From the viewpoint of the impact resistance, moldability, fluidity, and appearance of the thermoplastic resin composition obtained, the volume average particle diameter of the rubbery polymer (a1) is preferably 50 to 500 nm, more preferably 180 to 440 nm, and even more preferably 280 to 380 nm.

The volume average particle diameter of the rubbery polymer (a1) is a value measured by the method described in the paragraphs for Examples described later.

<Vinyl Monomer Mixture (a2)>

The vinyl monomer mixture (a2) (hereinafter sometimes referred to as “component (a2)”) is a vinyl monomer mixture containing at least an aromatic vinyl monomer and a vinyl cyanide monomer.

Examples of the aromatic vinyl monomer include styrene, α-methylstyrene, p-methylstyrene, vinyltoluene, t-butylstyrene, o-ethylstyrene, o-chlorostyrene, and o,p-dichlorostyrene. These may be used alone or in combination of two or more.

Examples of vinyl cyanide monomer include acrylonitrile, methacrylonitrile, ethacrylonitrile, and the like. In particular, acrylonitrile is preferred. Regarding vinyl cyanide monomers, only one type may be used, or two or more types may be used in combination.

The ratio of the aromatic vinyl monomer and the vinyl cyanide monomer in 100% by mass of the vinyl monomer mixture (a2) is determined from the viewpoint of the moldability of the resulting thermoplastic resin composition and the appearance of the molded article. It is preferably the aromatic vinyl monomer/the vinyl cyanide monomer=60 to 90% by mass/10 to 40% by mass, more preferably 65 to 80% by mass/20 to 35% by mass, and even more preferably 67 to 76% by mass/24 to 33% by mass.

The vinyl monomer mixture (a2) may include, in addition to the aromatic vinyl monomer and the vinyl cyanide monomer, another vinyl monomer copolymerizable with these in the range of 0% to 30% by mass. Examples of the another vinyl monomer copolymerizable with these include at least one of unsaturated carboxylic acid ester monomers such as methyl (meth)acrylate, and the like, maleimide monomers such as N-methylmaleimide, N-cyclohexylmaleimide, N-phenylmaleimide, and the like, unsaturated dicarboxylic acids such as maleic acid, and the like, unsaturated dicarboxylic acid anhydrides such as maleic anhydride, and the like, and unsaturated amides such as acrylamide, and the like, but the vinyl monomer is not limited to these. Among these, methyl (meth)acrylate, N-phenylmaleimide, and maleic anhydride are preferable.

“(Meth)acrylic acid” denotes one of or both “acrylic acid” and “methacrylic acid”.

<Proportion of Rubbery Polymer (a1) and Vinyl Monomer Mixture (a2)>

The rubber-containing graft copolymer (A) is preferably produced by graft-polymerizing 25 to 80% by mass of vinyl monomer mixture (a2) in the presence of 20 to 75% by mass of rubbery polymer (a1). In this regard, the total of the rubbery polymer (a1) and the vinyl monomer mixture (a2) is 100% by mass.

When the rubbery polymer (a1) is less than 20% by mass, and the vinyl monomer mixture (a2) is more than 80% by mass, the resulting thermoplastic resin composition tends to have poor impact resistance. When the rubbery polymer (a1) is more than 75% by mass, and the vinyl monomer mixture (a2) is less than 25% by mass, the impact resistance and moldability tend to decrease. The proportion of the rubbery polymer (a1) is preferably 30 to 70% by mass, and more preferably 40 to 65% by mass. The proportion of the vinyl monomer mixture (a2) is preferably 30 to 70% by mass, and more preferably 35 to 60% by mass.

The entire amount of the vinyl monomer mixture (a2) is not necessarily grafted, and the rubber-containing graft copolymer (A) obtained as a mixture with a copolymer that is not grafted is used usually. This mixture is essentially a composition but is included in the rubber-containing graft copolymer (A) in the present invention.

### <Graft Rate>

There is no particular limitation regarding the graft rate of the rubber-containing graft copolymer (A), but, from the viewpoint of the impact resistance, the graft rate is preferably 10 to 150% by mass, more preferably 15% to 100% by mass, and even more preferably 20 to 60% by mass.

The graft rate of the rubber-containing graft copolymer (A) is measured by a method described in the paragraphs for Examples described later.

### <Molecular Weight of Ungrafted Copolymer>

The composition of the non-grafted copolymer in the rubber-containing graft copolymer (A) falls within the range of the blending ratio of the monomer components.

The weight average molecular weight (Mw) of the ungrafted copolymer is preferably 20,000 to 400,000, more preferably 30,000 to 200,000, and even more preferably 40,000 to 100,000.

The molecular weight distribution (Mw/Mn) of the ungrafted copolymer is preferably 1.5 to 4.0, more preferably 1.7 to 3.6, and even more preferably 1.8 to 3.2.

When the weight average molecular weight (Mw) and molecular weight distribution (Mw/Mn) are within the above ranges, the resulting thermoplastic resin composition tends to have better fluidity, impact resistance, and paintability.

The weight average molecular weight and molecular weight distribution of the non-grafted copolymer can be measured as a polystyrene equivalent values by GPC. The details are as described in the paragraphs for Examples described later.

### <Graft Polymerization Method>

There is no particular limitation regarding the method for graft-polymerizing the rubber-containing graft copolymer (A), and production of the rubber-containing graft copolymer (A) can be performed by using any known method, such as an emulsion polymerization method, a suspension polymerization method, a continuous bulk polymerization method, a continuous solution polymerization method, and the like. Preferably, the rubber-containing graft copolymer (A) is produced by using an emulsion polymerization method or a bulk polymerization method. Since the emulsifier content and the amount of water in the rubber-containing graft copolymer (A) are readily adjusted, it is most preferable that the rubber-containing graft copolymer (A) is produced by using the emulsion polymerization method.

Depending on the purpose, the rubber-containing graft copolymer (A) may be used by blending a plurality of separately produced rubber-containing graft copolymers having different rubber particle sizes or compositions.

### <Content of Rubber-Containing Graft Copolymer (A)>

In the thermoplastic resin composition of the present invention, the content of the component (A) in a total of 100 parts by mass of the components (A) to (C) is 10 to 50 parts by mass, preferably 20 to 40 parts by mass, more preferably 25 to 35 parts by mass, and even more preferably 26 to 34 parts by mass. When the content of the component (A) is more than or equal to the above-mentioned lower limit, the impact resistance and paintability will be good. When the content of the component (A) is less than or equal to the above-mentioned upper limit, the moldability and heat resistance will be good.

The content of the rubbery polymer (a1) in 100% by mass of the thermoplastic resin composition of the present invention is preferably 10 to 30% by mass, more preferably 12 to 28% by mass, and even more preferably 15 to 25% by mass. When the content of the rubbery polymer (a1) is more than or equal to the above-mentioned lower limit, the impact resistance will be good. When the content of the rubbery polymer (a1) is less than or equal to the above-mentioned upper limit, the moldability and gloss will be good.

### [Vinyl Cyanide-Maleimide Copolymer (B)]

The vinyl cyanide-maleimide copolymer (B) is a vinyl cyanide-maleimide copolymer obtained by copolymerizing 5 to 30% by mass of a vinyl cyanide monomer (b1) (hereinafter sometimes referred to as “component (b1)”), and 20 to 60% by mass of a maleimide monomer (b2) (hereinafter sometimes referred to as “component (b2)”), and 10 to 75% by mass of an another vinyl monomer (b3) (hereinafter sometimes referred to as “component (b3)”) copolymerizable with these (where a total of (b1), (b2), and (b3) is 100% by mass).

Examples of the vinyl cyanide monomer (b1) include acrylonitrile, methacrylonitrile, ethacrylonitrile, and the like. Among these, acrylonitrile is particularly preferred. The vinyl cyanide monomers may be used alone or in combination of two or more.

Examples of the maleimide monomer (b2) include N-methylmaleimide, N-cyclohexylmaleimide, N-phenylmaleimide, and the like. Among these, N-cyclohexylmaleimide and N-phenylmaleimide are preferred, and N-phenylmaleimide is particularly preferred. The maleimide monomers may be used alone or in combination of two or more.

Examples of the another vinyl monomer (b3) copolymerizable with the component (b1) and the component (b2) include one or more of aromatic vinyl monomers, unsaturated carboxylic acid ester monomers such as methyl (meth)acrylate, and the like, unsaturated dicarboxylic acids such as maleic acid, and the like, unsaturated dicarboxylic anhydrides such as maleic anhydride, and the like, or unsaturated amides such as acrylamide, and the like, but are not limited to these. Among these, aromatic vinyl monomers are preferred.

Examples of the aromatic vinyl monomer include styrene, α-methylstyrene, p-methylstyrene, vinyltoluene, t-butylstyrene, o-ethylstyrene, o-chlorostyrene, and o,p-dichlorostyrene. These may be used alone or in combination of two or more.

From the viewpoint of the heat resistance, paintability, and durability of the thermoplastic resin composition obtained, the content of each monomer in 100% by mass of the raw vinyl monomer mixture used for producing the vinyl cyanide-maleimide copolymer (B) is 5 to 30% by mass of the vinyl cyanide monomer (b1), 20 to 60% by mass of the maleimide monomer (b2), and 10 to 75% by mass of the another vinyl monomer (b3) copolymerizable with these (where a total of the component (b1), the component (b2), and the component (b3) is 100% by mass). It is preferably 6 to 28% by mass of the vinyl cyanide monomer (b1), 25 to 58% by mass of the maleimide monomer (b2) and 14 to 69% by mass of the another vinyl monomer (b3) copolymerizable with these. It is more preferably 7 to 25% by mass of the vinyl cyanide monomer (b1), 30 to 57% by mass of the maleimide monomer (b2), and 18 to 63% by mass of the another vinyl monomer (b3) copolymerizable with these. It is even more preferably 8 to 22% by mass of the vinyl cyanide monomer (b1), 40 to 55% by mass of the maleimide monomer (b2), and 23 to 52% by mass of the another vinyl monomer (b3) copolymerizable with these. It is most preferably 9 to 19% by mass of the vinyl cyanide monomer (b1), 41 to 53% by mass of the maleimide monomer (b2), and 28 to 50% by mass of the another vinyl monomer (b3) copolymerizable with these.

The weight average molecular weight (Mw) of the vinyl cyanide-maleimide copolymer (B) is preferably 50,000 to 300,000, and more preferably 80,000 to 200,000.

The weight average molecular weight of the vinyl cyanide-maleimide copolymer (B) can be measured as a polystyrene equivalent value by GPC. The details are as described in the paragraphs for Examples described later.

Only one type of the vinyl cyanide-maleimide copolymer (B) may be used, or two or more types having different monomer compositions, molecular weights, etc. may be used as a mixture.

In the thermoplastic resin composition of the present invention, the content of the component (B) in a total of 100 parts by mass of the components (A) to (C) is 5 to 90 parts by mass, preferably 20 to 70 parts by mass, more preferably 40 to 60 parts by mass, and even more preferably 42 to 58 parts by mass. When the content of the component (B) is more than or equal to the above-mentioned lower limit, it will be excellent in the heat resistance, paintability, and durability. When the content of the component (B) is less than or equal to the above-mentioned upper limit, it will be excellent in the fluidity and impact resistance.

### [Vinyl Cyanide-Aromatic Vinyl Copolymer (C)]

The vinyl cyanide-aromatic vinyl copolymer (C) is a copolymer obtained by copolymerizing a vinyl monomer mixture containing a vinyl cyanide monomer and an aromatic vinyl monomer.

Examples of the vinyl cyanide monomer include acrylonitrile, methaacrylonitrile, ethacrylonitrile, and the like. Among these, acrylonitrile is particularly preferred. The vinyl cyanide monomers may be used alone or in combination of two or more.

Examples of the aromatic vinyl monomer include styrene, α-methylstyrene, p-methylstyrene, vinyltoluene, t-butylstyrene, o-ethylstyrene, o-chlorostyrene, and o,p-dichlorostyrene. These may be used alone or in combination of two or more.

The ratio of the vinyl cyanide monomer and the aromatic vinyl monomer in 100% by mass of the vinyl monomer mixture (c1) is determined from the viewpoint of the moldability and paintability of the resulting thermoplastic resin composition, and it is preferably the vinyl cyanide monomer/the aromatic vinyl monomer=20 to 40% by mass/60 to 80% by mass, more preferably 22 to 38% by mass/62 to 78% by mass, even more preferably 24 to 35% by mass/65 to 76% by mass, and most preferably 25 to 29% by mass/71 to 75% by mass.

The vinyl monomer mixture (c1) may include, in addition to the aromatic vinyl monomer and the vinyl cyanide monomer, another vinyl monomer copolymerizable with these in the range of 0% to 30% by mass. Examples of the another vinyl monomer copolymerizable with these include at least one of unsaturated carboxylic acid ester monomers such as methyl (meth)acrylate, and the like, maleimide monomers such as N-methylmaleimide, N-cyclohexylmaleimide, N-phenylmaleimide, and the like, unsaturated dicarboxylic acids such as maleic acid, and the like, unsaturated dicarboxylic acid anhydrides such as maleic anhydride, and the like, and unsaturated amides such as acrylamide, and the like, but the vinyl monomer is not limited to these. Among these, methyl (meth)acrylate, N-phenylmaleimide, and maleic anhydride are preferable.

The weight average molecular weight (Mw) of the vinyl cyanide-aromatic vinyl copolymer (C) is preferably 50,000 to 300,000, more preferably 65,000 to 200,000, and even more preferably 80,000 to 150,000.

The molecular weight distribution (Mw/Mn) of the vinyl cyanide-aromatic vinyl copolymer (C) is preferably 1.3 to 2.8, more preferably 1.8 to 2.6, and even more preferably 1.7 to 2.4.

The weight average molecular weight and molecular weight distribution of the vinyl cyanide-aromatic vinyl copolymer (C) can be measured as a polystyrene equivalent values by GPC. The details are as described in the paragraphs for Examples described later.

Only one type of the vinyl cyanide-aromatic vinyl copolymer (C) may be used, or two or more types having different monomer compositions, molecular weights, etc. may be used as a mixture.

In the thermoplastic resin composition of the present invention, the content of the component (C) in a total of 100 parts by mass of the components (A) to (C) is 0 to 45 parts by mass, preferably 10 to 40 parts by mass, more preferably 15 to 25 parts by mass, and even more preferably 16 to 24 parts by mass. The component (C) is used as necessary to adjust the fluidity, heat resistance, and impact resistance. When the content of the component (C) is more than or equal to the above-mentioned lower limit, the fluidity and heat resistance can be adjusted. When the content of the component (C) is less than or equal to the above-mentioned upper limit, the heat resistance and impact resistance can be adjusted.

### [Polymerization Method of Component (B) and Component (C)]

There are no particular restrictions on the polymerization method for the vinyl cyanide-maleimide copolymer (B) and the vinyl cyanide-aromatic vinyl copolymer (C). The productions of the vinyl cyanide-maleimide copolymer (B) and the vinyl cyanide-aromatic vinyl copolymer (C) can be performed by using any known method such as an emulsion polymerization method, a suspension polymerization method, a continuous bulk polymerization method, a continuous solution polymerization method, and the like. In order to improve the paintability and durability in the present invention, and further to suppress gas during molding, the production is preferably carried out by a suspension polymerization method, a continuous bulk polymerization method, or a continuous solution polymerization method. The reason for this is as follows.

In a total of 100 parts by mass of the component (A), the component (B), and the component (C), the total proportion of the component (B) and the component (C) occupies 50 to 90 parts by mass. Therefore, the method for producing the component (B) and the component (C) has a large influence on the entire production process of the thermoplastic resin composition.

The component (A) needs to have a graft structure by emulsion polymerization. However, when the other components (B) and (C) are produced by an emulsion polymerization, a washing step is required for gas suppression and the like. This not only leads to energy consumption for wastewater treatment in subsequent processes, but also increases the impact on the environment.

For this reason, the component (B) and the component (C) are preferably produced by a suspension polymerization method, a continuous bulk polymerization method, or a continuous solution polymerization method other than an emulsion polymerization method.

### [Content of Maleimide Monomer Unit]

The content of the maleimide monomer unit in the thermoplastic resin composition of the present invention is 10 to 45 parts by mass as a ratio to a total of 100 parts by mass of the component (A), the component (B), and the component (C). (Hereinafter, this ratio is simply referred to as “maleimide monomer unit content”.)

When the maleimide monomer unit content is more than or equal to the above-mentioned lower limit, the thermoplastic resin composition of the present invention can exhibit the heat resistance and durability. When the maleimide monomer unit content is less than or equal to the above-mentioned upper limit, the thermoplastic resin composition of the present invention can exhibit the fluidity and impact resistance. The maleimide monomer unit content of the thermoplastic resin composition of the present invention is preferably 13 to 30 parts by mass, more preferably 16 to 28 parts by mass, even more preferably 18 to 26 parts by mass, and particularly preferably 20 to 24 parts by mass.

The maleimide monomer unit is a structural unit contained in the copolymer derived from the maleimide monomer used as a raw material for each copolymer. The maleimide monomer unit is not limited to the maleimide monomer (b2) of the raw material monomer mixture of the component (B). The maleimide monomer unit is contained in the vinyl monomer mixture (a2) of the rubber-containing graft copolymer (A) and is contained in the thermoplastic resin composition as a structural unit of the rubber-containing graft copolymer (A). It may be contained in the vinyl monomer mixture (c1) of the vinyl cyanide-aromatic vinyl copolymer (C) and contained in the thermoplastic resin composition as a structural unit of the vinyl cyanide-aromatic vinyl copolymer (C). Furthermore, when maleimide monomer units are included in the other resin components described below, the maleimide monomer units are also totaled as maleimide monomer units in the thermoplastic resin composition.

The maleimide monomer unit content in the thermoplastic resin composition can be confirmed by measuring the content of nitrogen elements and oxygen elements by elemental analysis. The maleimide monomer unit content in the thermoplastic resin composition can also be calculated as the content of maleimide monomers in the raw materials for producing each copolymer constituting the thermoplastic resin composition. In the Examples below, the content of the maleimide monomer in the component (B) was measured using an elemental analyzer, and the maleimide monomer unit content in the thermoplastic resin composition was calculated from the proportion of the component (B) in a total of 100 parts by mass of the components (A) to (C).

### [Olefin Resin (D)]

In addition to the above components (A), (B), and (C), the thermoplastic resin composition of the present invention may contain an olefin resin (D) (hereinafter sometimes referred to as “component (D)”).

Examples of the olefin resin (D) include a polyolefin resin (d1) and/or a modified polyolefin resin (d2).

<Polyolefin Resin (d1)>

The polyolefin resin (d1) (hereinafter sometimes referred to as “component (d1)”) is preferably an unmodified (co)polymer comprising at least one structural unit derived from an α-olefin having 2 or more carbon atoms. In the present invention, a particularly preferred component (d1) is a polyolefin resin comprising at least one structural unit derived from an α-olefin having 2 to 10 carbon atoms.

Examples of the α-olefin include ethylene, propylene, butene-1, pentene-1, hexene-1, 3-methylbutene-1, 4-methylpentene-1, 3-methylhexene-1, and the like. Among these, ethylene, propylene, butene-1, 3-methylbutene-1 and 4-methylpentene-1 are preferred, and propylene is particularly preferred.

Examples of the component (d1) include polyethylene, polypropylene, ethylene/propylene copolymer, polybutene-1, ethylene/butene-1 copolymer, and the like. Among these, polyethylene, polypropylene, and propylene/ethylene copolymer are preferred. From the viewpoint of the appearance and mechanical strength of the obtained thermoplastic resin molded article, polypropylene resins containing 85% by mass or more of propylene units based on the total structural units, that is, polypropylene and ethylene-propylene copolymers are more preferred. Examples of the ethylene/propylene copolymer include random copolymers, block copolymers, and the like, and random copolymers are particularly preferred.

The above component (d1) may be crystalline or amorphous. Preferably, it has a crystallinity of 20% or more as determined by X-ray diffraction at room temperature.

The molecular weight of the component (d1) is not particularly limited. However, from the viewpoint of the appearance and mechanical strength of the obtained thermoplastic resin molded article, the melt mass flow rate (hereinafter also referred to as “MFR”) measured at a temperature of 190° C. and a load of 2.16 kg according to JIS K7210 is preferably 0.1 to 50 g/10 minutes, and more preferably 0.5 to 30 g/10 minutes. The component (d1) preferably has a molecular weight corresponding to these values.

Commercially available products can also be used as the component (d1). For example, polypropylene having the trade names “Novatec FY6” and “Novatec FY4” (both manufactured by Japan Polypropylene Corporation) can be suitably used.

The thermoplastic resin composition of the present invention may contain only one type of the component (d1), or may contain two or more types.

<Modified Polyolefin Resin (d2)>

The modified polyolefin resin (d2) (hereinafter sometimes referred to as “component (d2)”) is an acid-modified polyolefin resin. For Example, as the component (d2), modified products obtained by grafting a polyolefin resin with unsaturated carboxylic acids such as acrylic acid, methacrylic acid, maleic acid, fumaric acid, maleic anhydride, itaconic anhydride, and the like, siloxane, and the like, can be used. Particularly preferred as the component (d2) is maleic anhydride-modified polyolefin resin.

The acid value of the modified polyolefin resin (d2) according to JIS K0070 is preferably 20 to 70 mgKOH/g. The melt viscosity of the modified polyolefin resin (d2) at 160° C. is preferably 1,000 to 20,0000 mPa-s, and more preferably 2,000 to 12,0000 mPa-s.

Commercially available products can also be used as the component (d2). For example, the trade names “UMEX 1001” and “UMEX 1010” (both manufactured by Sanyo Chemical Industries, Ltd.) can be suitably used.

The thermoplastic resin composition of the present invention may contain only one type of the component (d2), or may contain two or more types.

### <Content of Olefin Resin (D)>

When the thermoplastic resin composition of the present invention contains the olefin resin (D), the content of the polyolefin resin (d1) and/or the modified polyolefin resin (d2) as the olefin resin (D) is preferably 0.1 to 15 parts by mass, more preferably 0.3 to 10 parts by mass, even more preferably 0.5 to 5 parts by mass, and particularly preferably 0.8 to 3 parts by mass based on a total of 100 parts by mass of the component (A), the component (B) and the component (C).

When the blending amount of the olefin resin (D) is more than or equal to the above-mentioned lower limit, the paintability of the molded article made from the thermoplastic resin composition of the present invention can be improved. When the blending amount of the olefin resin (D) is less than or equal to the above-mentioned upper limit, better heat resistance, durability, and appearance can be achieved.

### [Ethylene-(Meth)Acrylic Acid Ester-Carbon Monoxide Copolymer (E)]

The thermoplastic resin composition of the present invention may contain, in addition to the above components (A), (B), and (C), an ethylene-(meth)acrylic acid ester-carbon monoxide copolymer (E) (hereinafter sometimes referred to as “component (E)”).

The ethylene-(meth)acrylic ester-carbon monoxide copolymer (E) is a copolymer obtained by copolymerizing at least ethylene, (meth)acrylic ester, and carbon monoxide. The component (E) may be a random copolymer or a block copolymer, but is preferably a random copolymer. The component (E) may be obtained by further copolymerizing other monomers copolymerizable with these. By blending the ethylene-(meth)acrylic acid ester-carbon monoxide copolymer (E), it is possible to further suppress the occurrence of paint surface popping on the resulting thermoplastic resin molded article.

The (meth)acrylic ester in the ethylene-(meth)acrylic ester-carbon monoxide copolymer (E) is preferably an ester of (meth)acrylic acid and an alcohol having 1 to 8 carbon atoms. Examples of the (meth)acrylic ester include methyl (meth)acrylate, ethyl (meth)acrylate, n-propyl (meth)acrylate, n-butyl (meth)acrylate, sec-butyl (meth)acrylate, t-butyl (meth)acrylate, isobutyl (meth)acrylate, hexyl (meth)acrylate, 2-ethylhexyl (meth)acrylate, octyl (meth)acrylate, and the like. Two or more types of these may be used. Among these, methyl (meth)acrylate, ethyl (meth)acrylate, n-propyl (meth)acrylate, n-butyl (meth)acrylate, sec-butyl (meth)acrylate, t-butyl (meth)acrylate, and isobutyl (meth)acrylate are are preferred.

The glass transition temperature of the ethylene-(meth)acrylic ester-carbon monoxide copolymer (E) is preferably −60° C. to −20° C., and particularly preferably −48° C. to −35° C.

The melting point of the ethylene-(meth)acrylic acid ester-carbon monoxide copolymer (E) is preferably in the range of 30° C. to 80° C.

When the glass transition temperature and the melting point are in this range, the paintability such as paint surface popping resistance will be excellent under environmental factors (for example, in summer and winter).

Commercially available products can also be used as the component (E). For example, the trade name “Elvaloy HP661” (manufactured by DuPont Mitsui Polychemicals Co., Ltd.) can be suitably used.

The thermoplastic resin composition of the present invention may contain only one type of the component (E), or may contain two or more types.

When the thermoplastic resin composition of the present invention contains the ethylene-(meth)acrylic ester-carbon monoxide copolymer (E), the content of the ethylene-(meth)acrylic ester-carbon monoxide copolymer (E) is preferably 0.1 to 15 parts by mass, more preferably 0.3 to 10 parts by mass, even more preferably 0.5 to 5 parts by mass, and particularly preferably 0.8 to 3 parts by mass based on a total of 100 parts by mass of the component (A), the component (B), and the component (C).

When the content of the ethylene-(meth)acrylic acid ester-carbon monoxide copolymer (E) is more than or equal to the above-mentioned lower limit, it is possible to further improve the paintability of the molded article made of the thermoplastic resin composition of the present invention. When the content of the ethylene-(meth)acrylic acid ester-carbon monoxide copolymer (E) is less than or equal to the above-mentioned upper limit, better heat resistance, durability, and appearance can be achieved.

### [Content of Component (D) and Component (E)]

By blending the thermoplastic resin composition of the present invention in combination with the above component (D) and the component (E), a synergistic effect may be obtained. By blending the component (D) and the component (E) in combination, the above effects can be effectively obtained while reducing the total blending amount.

Specifically, the total content of the component (D) and the component (E) in the thermoplastic resin composition of the present invention is preferably 0.2 to 15 parts by mass, more preferably 0.6 to 10 parts by mass, even more preferably 1 to 6 parts by mass, particularly preferably 1.5 to 4 parts by mass, and most preferably 1.8 to 3 parts by mass based on a total of 100 parts by mass of the component (A), the component (B), and the component (C).

In addition, when using the component (D) and the component (E) together, from the viewpoint of obtaining a synergistic effect by the combination more effectively, the content mass ratio of the component (D) and the component (E) is preferably the component (D): the component (E)=1:0.5 to 3, and more preferably the component (D): the component (E)=1:0.8 to 1.5.

### [Other Additives]

To improve the performance as a forming resin, various additives may be added to the thermoplastic resin composition according to the present invention within the bound of not impairing the object of the present invention.

For example, as the situation demands, various stabilizers, such as antioxidants of hindered phenol base, sulfur-containing organic compound base, phosphorus-containing organic compound base, and the like, heat stabilizers of phenol base, acrylate base, and the like, transesterification inhibitors e.g. a mixture of monostearyl acid phosphate and distearyl acid phosphate, ultraviolet absorbers of benzotriazole base, benzophenone base, salicylate base, and the like, and light stabilizers of organic nickel base, hindered amine base, and the like; lubricants, such as higher fatty acid metal salts and higher fatty acid amides; plasticizers, such as phthalic acid esters and phosphoric acid esters; flame retardants and flame retardant auxiliaries, such as halogen-containing compounds e.g. polybromodiphenyl ether, tetrabromobisphenol A, brominated epoxy oligomers, and brominated polycarbonate oligomers, phosphorus-based compounds, and antimony trioxide; and carbon black, pigments, dyes, and the like may be added.

### [Other Resins]

The thermoplastic resin composition of the present invention may contain one or more resins other than the above-mentioned components (A) to (E), such as a fluororesin, an impact modifier, AS resins having a molecular weight of 500,000 or more, and the like, as long as the object of the present invention is not impaired. In this case, the amount of other resins is preferably 10 parts by mass or less based on a total of 100 parts by mass of the components (A) to (E) and other resins.

### [Method for Producing Thermoplastic Resin Composition]

The thermoplastic resin composition according to the present invention can be produced by using various methods. For example, the thermoplastic resin composition according to the present invention can be produced by melt-kneading the above-mentioned components (A) and (B), or the components (A) to (C), or the components (A) to (C) and the component (D) and/or the component (E), furthermore, the above-mentioned additives and other resins which are used as the situation demands using a Banbury mixer, a roll, or a single-screw or multi-screw extruder.

### [Thermoplastic Resin Molded Article]

The thermoplastic resin molded article according to the present invention is obtained by molding the thermoplastic resin composition according to the present invention by using a known molding method.

Examples of the molding method include an injection molding method, a press molding method, an extrusion molding method, a vacuum forming method, and a blow molding method.

The thermoplastic resin molded article according to the present invention produced by molding the thermoplastic resin composition according to the present invention has excellent paintability, high heat resistance, and excellent appearance, and has a lower specific gravity and lighter weight than alloy materials such as polycarbonate. Furthermore, it exhibits excellent durability against fatigue fractures caused by vibrations, etc. The thermoplastic resin molded article according to the present invention may be used as electronic components, automobile components, machine mechanism components, OA equipment, housing components of home electric appliances, general merchandise, housing construction materials, and the like. The thermoplastic resin molded article of the present invention can be particularly suitably used as a lightweight material for spoilers of automobile parts.

In particular, the thermoplastic resin molded article of the present invention is useful as a painted part whose surface is coated because of its excellent paintability.

### EXAMPLES

To further specifically explain the present invention, the description will be provided below with reference to the examples and the comparative examples. These examples do not limit the present invention. “%” expresses % by mass, and “part” expresses part by mass, unless otherwise specified.

In the following, the volume average particle diameter of the rubbery polymer (a1) was measured as described (1) below.

The graft rate of the rubber-containing graft copolymer (A) was measured as described (2) below.

The weight average molecular weight (Mw) and the molecular weight distribution (Mw/Mn) of the acetone-soluble matter (non-grafted copolymer) of the rubber-containing graft copolymer (A) and the vinyl cyanide-aromatic vinyl copolymer (C) were measured as described (3) below.

### (1) Volume Average Particle Diameter

The volume average particle diameter of the rubbery polymer (a1) in a latex was measured at room temperature by using “Microtrac UPA150” (trade name) manufactured by HONEYWELL. The unit is nm.

It is known that there is substantially no difference between the latex particle diameter of the rubbery polymer (a1) and the rubber particle diameter of the rubbery polymer (a1) in the resin composition by using the rubbery polymer (a1), and the former is in accord with the latter.

### (2) Graft Rate

The graft rate of the rubber-containing graft copolymer (A) is calculated on the basis of a formula below.

$$graft rate ( \% by mass ) = \{ [ ( n ) - ( m ) \times L ] / [ ( m ) \times L ] \} \times 100$$

In the above-mentioned formula, n represents mass n (g) of acetone-insoluble matters obtained by placing about 1 g [weighing capacity: m (g)] of the rubber-containing graft copolymer (A) into 20 ml of acetone, performing shaking for 2 hours by using a shaker under a temperature condition of 25° C., and performing centrifugal separation for 60 minutes by using a centrifuge (rotational speed: 23,000 rpm) under a temperature condition of 5° C. so as to separate acetone-insoluble matters and acetone-soluble matters from each other.

L represents the mass (g) of the rubbery polymer (a1) contained in the rubber-containing graft copolymer (A).

The mass of the rubbery polymer (a1) may be determined by using a method for calculating from the polymerization proportion and the degree of polymerization conversion, a method for determining based on the infrared absorption spectrum, or the like.

### (3) Weight Average Molecular Weight (Mw) and Molecular Weight Distribution (Mw/Mn)

The weight average molecular weight (Mw) and the molecular weight distribution (Mw/Mn) were determined using GPC (GPC: “GPC/V2000” manufactured by Waters Corporation, column: “Shodex AT-G+AT-806MS” manufactured by Showa Denko K.K.) and o-dichlorobenzene (145° C.) as a solvent and determined in terms of a polystyrene.

For the measurement sample of the non-grafted copolymer, the acetone-soluble content with the above-mentioned graft rate was dropped into methanol to precipitate the polymer component, and then the solid content was filtered out and dried in a vacuum dryer for 24 hours. The dried product was used for GPC measurement.

In the GPC measurement of the component (B), after dissolving the component (B) in acetone, the polymer component was precipitated in methanol, dried for 24 hours in a vacuum dryer, and used for the GPC measurement.

### (4) Maleimide Monomer Unit Content

Regarding the component (B) prepared in the same manner as the sample for GPC measurement, nitrogen element (N) and oxygen element (O) were measured using the following elemental analyzer.
Nitrogen elemental analysis: JM10 MICRO CORDER (manufactured by J-SCIENCE-LAB Co., Ltd.)
Oxygen elemental analysis: JMO12 MICRO CORDER (manufactured by J-SCIENCE-LAB Co., Ltd.)

The maleimide monomer unit content in the component (B) was determined from the ratio of nitrogen element (N) and oxygen element (O) present in the component (B).

The content of vinyl cyanide monomer was also determined from the amount of the remaining nitrogen element (N).

### Rubber-Containing Graft Copolymer (A)

### Synthesis Example 1: Production of Rubber-Containing Graft Copolymer (A1)

The interior of a reactor was replaced with nitrogen, and 120 parts of pure water, 0.5 parts of glucose, 0.5 parts of sodium pyrophosphate, 0.005 parts of ferrous sulfate, and 60 parts (in terms of solid contents) of polybutadiene latex having a volume average particle diameter of 340 nm as the rubbery polymer (a1) were charged, and the temperature in the reactor was increased to 65° C. while agitation was performed. The point in time of the internal temperature reaching 65° C. was assumed to be the start of polymerization, and 29 parts of styrene and 11 parts of acrylonitrile as the component (a2), and 0.25 parts of a chain transfer agent, t-dodecylmercaptan mixture, were continuously added over 5 hours. Simultaneously, an aqueous solution composed of a polymerization initiator, cumenehydroperoxide (0.2 parts), and potassium oleate was continuously added over 7 hours so as to complete a reaction. The resulting latex was mixed with 1 part of 2,2′-methylenebis(4-methyl-6-t-butylphenol) relative to 100 parts of latex solid contents. Subsequently, the latex was solidified with sulfuric acid, neutralized with sodium hydroxide, washed, filtered, and dried so as to obtain a powder-like rubber-containing graft copolymer (A1).

The composition of the rubber-containing graft copolymer (A1) was AN/BD/ST=27/60/73, the rubber (the component (a1)) content was 60%, and the graft rate was 48%.

The weight average molecular weight of the acetone soluble matter of the rubber-containing graft copolymer (A1) was 58,000, and the molecular weight distribution was 3.1.

### Synthesis Example 2: Production of Rubber-Containing Graft Copolymer (A2)

A powdery rubber-containing graft copolymer (A2) was obtained by carrying out the reaction in the same manner as in Synthesis Example 1, except that the addition amount of the chain transfer agent t-dodecylmercaptan mixture was 0.19 parts.

The mass composition ratio of the rubber-containing graft copolymer (A2) was AN/BD/ST=27/60/73, the rubber (the component (a1)) content was 60%, and the graft rate was 62%.

The weight average molecular weight of the acetone soluble matter of the rubber-containing graft copolymer (A2) was 162,000, and the molecular weight distribution was 3.0.

### Vinyl Cyanide-Maleimide Copolymer (B)

### Synthesis Example 3: Production of Vinyl Cyanide-Maleimide Copolymer (B1)

11 parts of acrylonitrile (AN), 46 parts of N-phenylmaleimide (PMI), 43 parts of styrene (ST), 30 parts of methyl ethyl ketone, 0.01 part of 1,1′-azobis (cyclohexane-1-carbonitrile) and 0.05 part of t-dodecylmercaptan were continuously supplied to a 20-liter nitrogen-purged polymerization reactor having a stirring device. While the temperature inside the polymerization reactor was kept constant at 110° C., the polymerization reaction solution was continuously drawn out using a gear pump provided at the bottom of the polymerization reactor so that the average residence time was 2 hours. Subsequently, the polymerization reaction solution was kept in a heat exchanger maintained at 150° C. for about 20 minutes. Thereafter, the polymerization reaction solution was introduced into a two-vent type twin-screw extruder having a cylinder temperature of 230° C., and volatile components were devolatilized by setting the first vent section to atmospheric pressure and the second vent section to reduced pressure of 2.67 kPaabs. At this time, 0.38 parts of dicyclopentadiene was continuously added from before the second vent section. The strands discharged from the extruder were pelletized using a pelletizer to obtain a vinyl cyanide-maleimide copolymer (B1).

The mass composition ratio of the obtained vinyl cyanide-maleimide copolymer (B1) was AN/PMI/ST=11/46/43, and the weight average molecular weight (Mw) was 147,000.

### Synthesis Example 4: Production of Vinyl Cyanide-Maleimide Copolymer (B2)

A vinyl cyanide-maleimide copolymer (B2) was produced in the same manner as in Synthesis Example 3 except that the blending amounts of acrylonitrile, N-phenylmaleimide, and styrene were changed.

The mass composition ratio of the obtained vinyl cyanide-maleimide copolymer (B2) was AN/PMI/ST=17/29/54, and the weight average molecular weight (Mw) was 134,000.

### Synthesis Example 5: Production of Vinyl Cyanide-Maleimide Copolymer (B3)

A vinyl cyanide-maleimide copolymer (B3) was produced in the same manner as in Synthesis Example 3 except that the blending amounts of acrylonitrile, N-phenylmaleimide, and styrene were changed.

The mass composition ratio of the obtained vinyl cyanide-maleimide copolymer (B3) was AN/PMI/ST=5/46/49, and the weight average molecular weight (Mw) was 176,000.

### Synthesis Example 6: Production of Vinyl Cyanide-Maleimide Copolymer (B4)

A vinyl cyanide-maleimide copolymer (B4) was produced in the same manner as in Synthesis Example 3 except that the blending amounts of acrylonitrile, N-phenylmaleimide, and styrene were changed.

The mass composition ratio of the obtained vinyl cyanide-maleimide copolymer (B4) was AN/PMI/ST=25/46/29, and the weight average molecular weight (Mw) was 124,000.

### Synthesis Example 7: Production of Maleimide-Based Copolymer (B5) for Comparative Example

A maleimide-based copolymer (B5) was produced in the same manner as in Synthesis Example 3 except that acrylonitrile was not used, only N-phenylmaleimide and styrene were used, and the amount of t-dodecylmercaptan added was 0.07 parts.

The mass composition ratio of the obtained maleimide-based copolymer (B5) was AN/PMI/ST=0/55/45, and the weight average molecular weight (Mw) was 131,000.

### <Commercial Product: Maleimide-Based Copolymer for Comparative Example (B6)>

“Denka IP MS-NIP (trade name)” (styrene-N-phenylmaleimide-maleic anhydride copolymer) manufactured by Denka Company Limited was used as the maleimide-based copolymer (B6).

### Synthesis Example 8: Production of Vinyl Cyanide-Maleimide Copolymer (B7) for Comparative Example

A vinyl cyanide-maleimide copolymer (B7) was produced in the same manner as in Synthesis Example 3 except that the blending amounts of acrylonitrile, N-phenylmaleimide, and styrene were changed.

The mass composition ratio of the obtained copolymer (B7) was AN/PMI/ST=35/46/29, and the weight average molecular weight (Mw) was 103,000.

### Synthesis Example 9: Production of Vinyl Cyanide-Maleimide Copolymer (B8) for Reference Example

A monomer mixture consisting of 10 parts of acrylonitrile, 40 parts of N-phenylmaleimide, and 50 parts of styrene was subjected to emulsion polymerization using 3 parts of potassium stearate. Then the emulsion polymerization reaction solution was added to a 0.3% dilute aqueous sulfuric acid aqueous solution at a temperature of 90° C. to coagulate, and then neutralized with a sodium hydroxide aqueous solution. Thereafter, a vinyl cyanide-maleimide copolymer (B8) was obtained through washing, dehydration, and drying steps.

The mass composition ratio of the obtained vinyl cyanide-maleimide copolymer (B8) was AN/PMI/ST=10/40/50, and the weight average molecular weight (Mw) was 144,000.

### Vinyl Cyanide-Aromatic Vinyl Copolymer (C)

### Synthesis Example 10: Production of Vinyl Cyanide-Aromatic Vinyl Copolymer (C1)

The interior of a reactor was replaced with nitrogen, and 120 parts of water, 0.002 parts of sodium alkylbenzenesulfonate, 0.5 parts of polyvinyl alcohol, 0.3 parts of azoisobutyronitrile, 0.62 parts of t-dodecylmercaptan, and a monomer mixture composed of 32 parts of acrylonitrile and 68 parts of styrene were used, and the temperature was increased for 5 hours from a start temperature of 60° C. by heating while a portion of styrene was successively added so as to reach 120° C. Further, the reaction was performed at 120° C. for 4 hours. Thereafter, polymerized material was removed so as to obtain a vinyl cyanide-aromatic vinyl copolymer (C1) in which acrylonitrile/styrene=32/68 (mass ratio).

The obtained vinyl cyanide-aromatic vinyl copolymer (C1) had a weight average molecular weight (Mw) of 96,000 and a molecular weight distribution (Mw/Mn) of 2.1.

### Synthesis Example 11: Production of Vinyl Cyanide-Aromatic Vinyl Copolymer (C2)

A vinyl-aromatic vinyl copolymer (C2) in which acrylonitrile/styrene=27/73 was produced in the same manner as in Synthesis Example 10 except that the amount of t-dodecyl mercaptan added was 0.5 parts and a monomer mixture consisting of 27 parts of acrylonitrile and 73 parts of styrene was used.

The obtained vinyl cyanide-aromatic vinyl copolymer (C2) had a weight average molecular weight (Mw) of 112,000 and a molecular weight distribution (Mw/Mn) of 2.0.

### [Olefin Resin (D)]

<Olefin Resin (d1)>

Polypropylene “Novatec FY4” (trade name) manufactured by Japan Polypropylene Corporation was used. The MFR (temperature 190° C., load 2.16 kg) according to JIS K7210 is 5.0 g/10 minutes.

<Olefin Resin (d2)>

Maleic anhydride-modified polypropylene “Umex 1010” (trade name) manufactured by Sanyo Chemical Industries, Ltd. (melt viscosity at 160° C.: 6000 mPa-s, acid value according to JIS K0070: 52 mgKOH/g (catalog value)) was used.

### [Ethylene-(Meth)Acrylic Acid Ester-Carbon Monoxide Copolymer (E)]

Ethylene-n-butyl acrylate-carbon monoxide copolymer “Elvaloy HP661” (trade name) manufactured by DuPont Mitsui Polychemicals Co., Ltd. (glass transition temperature: −42° C., melting point: 60° C. (catalog value)) was used.

### Examples 1 to 29, Comparative Examples 1 to 10, and Reference Examples 1 and 2

The components (A), (B), (C) and the components (D) and (E) shown in Tables 1 to 4 are mixed in the proportions (parts) shown in Tables 1 to 4, and further, 0.2 parts of ADK stab “A-60 (trade name)” (tetrakis[methylene-3-(3′,5′-di-t-butyl-4′-hydroxyphenyl)propionate]methane) manufactured by ADEKA Corporation, and 0.5 part of KAO Wax EB-G (trade name) (ethylene bisstearamide) manufactured by Kao Corporation was mixed, and melt kneaded using a twin-screw extruder (“PCM30” manufactured by Ikegai Corporation) having a vacuum vent and having a screw diameter of 30 mm, at a cylinder temperature of 200 to 260° C. and a vacuum of 93.325 kPa. The kneaded material was taken as a strand and pelletized using a pelletizer (“SH type pelletizer” manufactured by SOUKEN Co., Ltd.) to obtain each thermoplastic resin composition (I).

The maleimide monomer unit content of the obtained thermoplastic resin composition (I) was calculated as the maleimide monomer content in the raw material of each copolymer. The values were shown in Tables 1 to 4.

The following tests were conducted using the thermoplastic resin composition (I). The results were shown in Tables 1 to 4.

### [Preparation of Evaluation Test Piece and Test Method]

<Preparation of Test Piece (a)>

For each pelletized thermoplastic resin composition (I), a test piece (a) of 150 mm×70 mm×3 mm was injection molded using an injection molding machine “IS-100GN” (model name) manufactured by TOSHIBA MACHINE CO., LTD. The resin temperature during injection molding was set to two conditions of 260° C. and 220° C. The mold temperature was 5° C., and the injection speed was 25 mm/s.

The test piece in which the resin temperature during injection molding was 260° C. was referred to as “test piece (a-1)”, and the test piece in which the resin temperature during injection molding was 220° C. was referred to as “test piece (a-2)”.

### <Paintability Evaluation: Evaluation of Popping>

The test pieces (a-1) and (a-2) were painted according to the following procedure. The painted surface was visually observed for the occurrence of the popping points, and the paintability was evaluated based on the following evaluation criteria.

### (1) Condition Adjustment

The test pieces (a-1) and (a-2) were left in a constant temperature bath adjusted to 5° C. for 12 hours or more to condition them.

### (2) Painting

A paint consisting of 80 parts of acrylic resin paint base, 85 parts of thinner for synthetic resin paint, and 10 parts of hardening agent was spray-painted (paint film thickness: 20 to 30 μm) to the surfaces (the side without the ejector pin marks) of the test pieces (a-1) and (a-2) and left at 23° C. for 5 minutes.

### (3) Drying

Thereafter, it was dried at 80° C. for 30 minutes to obtain a coated test piece.

### <Evaluation of Paint Defects (Paint Surface Popping)>

⊚: No popping points occurred on the surface of the test piece (suitable for use)
∘: 1 to 3 small popping points occurred on the surface of the test piece (usable)
Δ: 4 to 10 small popping points occurred on the surface of the test piece (barely usable)
x: 11 or more armpit popping points occurred on the surface of the test piece (unusable)
   <Preparation of Test Piece (b)>

Using an injection molding machine (“IS55FP-1.5A” (trade name) manufactured by SHIBAURA MACHINE Co., Ltd.), the thermoplastic resin composition (I) in the form of pellets was injection molded under the conditions of a cylinder temperature of 220 to 250° C. and a mold temperature of 60° C. to obtain a test piece (b) having a length of 80 mm, a width of 10 mm, and a thickness of 4 mm. The test piece (b) was used for measuring a Charpy impact strength and a temperature of deflection under load.

### <Impact Resistance Evaluation: Measurement of Charpy Impact Strength>

The test piece (b) was used, and the Charpy impact test (with a notch) was conducted at 23° C. in accordance with ISO 179 standard, and the Charpy impact strength was measured. The higher the value, the better the impact resistance.

### <Evaluation of Heat Resistance: Measurement of Temperature of Deflection Under Load (HDT: Heat Deflection Temperature)>

The test piece (b) was used, and HDT was measured under the conditions of a load of 1.80 MPa and a flat width (4 mm thickness) according to ISO 75 standard. The higher the HDT, the better the heat resistance.

### <Evaluation of Fluidity: Measurement of Melt Volume Rate (MVR)>

The pelletized thermoplastic resin composition (I) was used, and the MVR (cm³/10 min) of the thermoplastic resin composition (I) was measured under the conditions of a temperature of 220° C. and a load of 98 N (10 kg) according to ISO 1133 standard. MVR is an index of the fluidity of a thermoplastic resin composition, and the higher the MVR, the better the fluidity.

### <Evaluation of Molded Appearance>

The appearance of the test piece (a-2) was visually observed and evaluated according to the following criteria.
∘: No abnormality (suitable for use)
Δ: Slight flow marks and gas clouding, and the like occurred (usable)
x: Flow marks and gas clouding, and the like occurred (unusable)
   <Preparation of Test Piece (c)>

Using an injection molding machine (“IS55FP-1.5A” (trade name) manufactured by SHIBAURA MACHINE Co., Ltd.), the thermoplastic resin composition (I) in the form of pellets was injection molded under the conditions of a cylinder temperature of 220 to 250° C. and a mold temperature of 60° C. to obtain a test piece (c) having a thickness of 3.2 mm, and L=31.8 mm, b=20.6 mm, and L/b=1.54 according to the Type III test piece (wedge shape) of JIS K7119 “Plane bending fatigue test method for plastic flat plates”. The test piece (c) was used for a fatigue test.

### <Vibration Fatigue Test>

The test piece (c) was used, and the number of repetitions until breakage was measured under the following test conditions using the following testing machine. The greater the number of repetitions, the better the vibration fatigue resistance.
Testing machine: B-50 type repeated vibration fatigue testing machine manufactured by Toyo Seiki Seisaku-sho Ltd.
Test temperature: 80° C.
Test stress: 23 MPa
Test conditions: repetition rate 1800 times/min, frequency 30 Hz

TABLE 1

| | | | | Example | | | | | | | | | |
|---|---|---|---|---|---|---|---|---|---|---|---|---|---|
| | | | | 1 | 2 | 3 | 4 | 5 | 6 | 7 | 8 | 9 | 10 |
| Thermoplastic | Component (A) | | A1 | 30 | 30 | | 30 | 30 | 30 | 30 | 30 | 35 | 30 |
| Resin | | | A2 | | | 35 | | | | | | | |
| Composition | Component (B) | | B1 | 35 | 35 | 35 | 40 | 35 | 35 | 40 | 40 | 40 | 40 |
| Formulation | | | B2 | | | | | | | | | | |
| (parts by mass) | | | B3 | | | | | | | | | | |
| | | | B4 | | | | | | | | | | |
| | Comparative | | B5 | | | | | | | | | | |
| | Example | | B6 | | | | | | | | | | |
| | Component (B) | | B7 | | | | | | | | | | |
| | Reference Component (B) | | B8 | | | | | | | | | | |
| | Component (C) | | C1 | 35 | | 30 | 30 | 35 | | 30 | 30 | 25 | 30 |
| | | | C2 | | 35 | | | | 35 | | | | |
| | Component (D) | | d1 | | | | | | | | | | |
| | | | d2 | | | | | 1 | 1 | 1 | 2 | 2 | 3 |
| | Component (E) | | | | | | | | | | | | |
| Maleimide monomer unit content | | | parts by mass | 16.1 | 16.1 | 16.1 | 18.4 | 16.1 | 16.1 | 18.4 | 18.4 | 18.4 | 18.4 |
| Evaluation | Paintability | Test piece (a-1) | — | ◯ | ◯ | ◯ | ◯ | ◯ | ◯ | ◯ | ◯ | ⊚ | ⊚ |
| Results | (Popping points | Test piece (a-2) | — | Δ | Δ | Δ | Δ | ◯ | ◯ | ◯ | ◯ | ⊚ | ⊚ |
| | Evaluation) | | | | | | | | | | | | |

| | | | | | | | | | | | |
|---|---|---|---|---|---|---|---|---|---|---|---|
| HDT | ° C. | 99 | 98 | 99 | 100 | 99 | 98 | 99 | 99 | 97 | 98 |
| MVR | cm³/10 minutes | 16 | 17 | 11 | 13 | 16 | 17 | 13 | 13 | 11 | 14 |
| Charpy Impact Strength | kJ/m² | 11 | 12 | 10 | 11 | 11 | 12 | 9 | 8 | 10 | 7 |
| Molding Appearance | — | ◯ | ◯ | ◯ | ◯ | ◯ | ◯ | ◯ | ◯ | ◯ | ◯ |
| Vibration Fatigue | times | 4.4 × | 4.8 × | 4.2 × | 4.1 × | 4.1 × | 4.7 × | 4.0 × | 3.9 × | 3.8 × | 3.8 × |
| | | 10⁴ | 10⁴ | 10⁴ | 10⁴ | 10⁴ | 10⁴ | 10⁴ | 10⁴ | 10⁴ | 10⁴ |

TABLE 2

| | | | | Example | | | | | | | | | |
|---|---|---|---|---|---|---|---|---|---|---|---|---|---|
| | | | | 11 | 12 | 13 | 14 | 15 | 16 | 17 | 18 | 19 | 20 |
| Thermoplastic | Component (A) | | A1 | 30 | | 30 | 30 | 30 | 30 | 30 | 30 | 30 | 30 |
| Resin | | | A2 | | 30 | | | | | | | | |
| Composition | Component (B) | | B1 | 45 | 45 | 47 | 47 | 47 | 47 | 47 | 47 | 47 | 47 |
| Formulation | | | B2 | | | | | | | | | | |
| (parts by mass) | | | B3 | | | | | | | | | | |
| | | | B4 | | | | | | | | | | |
| | Comparative | | B5 | | | | | | | | | | |
| | Example | | B6 | | | | | | | | | | |
| | Component (B) | | B7 | | | | | | | | | | |
| | Reference Component (B) | | B8 | | | | | | | | | | |
| | Component (C) | | C1 | 25 | 25 | 23 | 23 | 23 | 23 | 23 | 23 | 23 | |
| | | | C2 | | | | | | | | | | 23 |
| | Component (D) | | d1 | | | | | | | 1 | 2 | | |
| | | | d2 | 2 | 2 | 1 | 2 | | | | | 1 | 2 |
| | Component (E) | | | | | | | 1 | 2 | 1 | | 1 | |
| Maleimide monomer unit content | | | parts by mass | 20.7 | 20.7 | 21.6 | 21.6 | 21.6 | 21.6 | 21.6 | 21.6 | 21.6 | 21.6 |
| Evaluation | Paintability | Test piece (a-1) | — | ⊚ | ⊚ | ⊚ | ⊚ | ⊚ | ⊚ | ⊚ | ⊚ | ⊚ | ⊚ |
| Results | (Popping points | Test piece (a-2) | — | ⊚ | ⊚ | ◯ | ◯ | ◯ | ◯ | ⊚ | ◯ | ⊚ | ◯ |
| | Evaluation) | | | | | | | | | | | | |

| | | | | | | | | | | | |
|---|---|---|---|---|---|---|---|---|---|---|---|
| HDT | ° C. | 102 | 104 | 103 | 103 | 103 | 103 | 103 | 103 | 103 | 103 |
| MVR | cm³/10 minutes | 11 | 13 | 10 | 10 | 10 | 10 | 10 | 10 | 10 | 10 |
| Charpy Impact Strength | kJ/m² | 7 | 6 | 9 | 9 | 9 | 9 | 9 | 9 | 9 | 9 |
| Molding Appearance | — | ◯ | ◯ | ◯ | ◯ | ◯ | ◯ | ◯ | ◯ | ◯ | ◯ |
| Vibration Fatigue | times | 3.8 × | 3.8 × | 4.1 × | 3.8 × | 4.0 × | 3.8 × | 3.8 × | 3.8 × | 3.8 × | 4.2 × |
| | | 10⁴ | 10⁴ | 10⁴ | 10⁴ | 10⁴ | 10⁴ | 10⁴ | 10⁴ | 10⁴ | 10⁴ |

TABLE 3

| | | | | Example | | | | | | | | |
|---|---|---|---|---|---|---|---|---|---|---|---|---|
| | | | | 21 | 22 | 23 | 24 | 25 | 26 | 27 | 28 | 29 |
| Thermoplastic | Component (A) | | A1 | 30 | 30 | 30 | 30 | 30 | 30 | 30 | 30 | 30 |
| Resin | | | A2 | | | | | | | | | |
| Composition | Component (B) | | B1 | 47 | | | | 47 | 47 | 47 | 30 | |
| Formulation | | | B2 | | 57 | | | | | | 27 | |
| (parts by mass) | | | B3 | | | 47 | | | | | | |
| | | | B4 | | | | 47 | | | | | |
| | Comparative | | B5 | | | | | | | | | |
| | Example | | B6 | | | | | | | | | |
| | Component (B) | | B7 | | | | | | | | | |
| | Reference Component (B) | | B8 | | | | | | | | | 47 |
| | Component (C) | | C1 | | | | | | | | | |
| | | | C2 | 23 | 13 | 23 | 23 | 23 | 23 | 23 | 13 | 23 |
| | Component (D) | | d1 | | | | | | | | | |
| | | | d2 | 1 | 1 | 1 | 1 | 15 | | 7.5 | 1 | 1 |
| | Component (E) | | | 1 | 1 | 1 | 1 | | 15 | 7.5 | 1 | 1 |
| Maleimide monomer unit content | | | parts by mass | 21.6 | 16.5 | 21.6 | 21.6 | 21.6 | 21.6 | 21.6 | 21.6 | 21.6 |
| Evaluation | Paintability | Test piece (a-1) | — | ⊚ | ⊚ | ⊚ | ⊚ | ⊚ | ⊚ | ⊚ | ⊚ | ⊚ |
| Results | (Popping points | Test piece (a-2) | — | ⊚ | ⊚ | ⊚ | ⊚ | ⊚ | ⊚ | ⊚ | ⊚ | ⊚ |
| | Evaluation) | | | | | | | | | | | |

| | | | | | | | | | | |
|---|---|---|---|---|---|---|---|---|---|---|
| HDT | ° C. | 103 | 97 | 103 | 103 | 90 | 90 | 90 | 99 | 101 |
| MVR | cm³/10 minutes | 10 | 11 | 10 | 10 | 22 | 20 | 21 | 11 | 12 |
| Charpy Impact Strength | kJ/m² | 9 | 10 | 10 | 8 | 5 | 7 | 6 | 8 | 7 |
| Molding Appearance | — | ◯ | ◯ | ◯ | ◯ | Δ~◯ | Δ~◯ | Δ~◯ | ◯ | Δ* |
| Vibration Fatigue | times | 4.5 × | 3.8 × | 3.8 × | 3.6 × | 2.2 × | 2.2 × | 2.2 × | 3.8 × | 3.2 × |
| | | 10⁴ | 10⁴ | 10⁴ | 10⁴ | 10⁴ | 10⁴ | 10⁴ | 10⁴ | 10⁴ |

*Gas fogging occurs.

TABLE 4

| | | | | | | | | | | | | | | Reference | |
|---|---|---|---|---|---|---|---|---|---|---|---|---|---|---|---|
| | | | | Comparative Example | | | | | | | | | | example | |
| | | | | 1 | 2 | 3 | 4 | 5 | 6 | 7 | 8 | 9 | 10 | 1 | 2 |
| Thermoplastic | Component (A) | | A1 | 30 | 30 | 30 | 30 | 30 | 30 | 30 | 30 | 30 | 30 | 30 | 30 |
| Resin | | | A2 | | | | | | | | | | | | |
| Composition | Component (B) | | B1 | | | | | | | | 20 | | | 35 | 35 |
| Formulation | | | B2 | | | | | | | | | 30 | | | |
| (parts by mass) | | | B3 | | | | | | | | | | | | |
| | | | B4 | | | | | | | | | | | | |
| | Comparative | | B5 | 30 | 35 | | | 40 | | | | | | | |
| | Example | | B6 | | | 30 | 35 | | 40 | | | | | | |
| | Component (B) | | B7 | | | | | | | 40 | | | | | |
| | Reference Component (B) | | B8 | | | | | | | | | | | | |
| | Component (C) | | C1 | | | 40 | 35 | 30 | 30 | 35 | 50 | 40 | 70 | 35 | 35 |
| | | | C2 | 40 | 35 | | | | | | | | | | |
| | Component (D) | | d1 | | | | | | | | | | | | |
| | | | d2 | | | | | 2 | 2 | 2 | 1 | 1 | 1 | 20 | |
| | Component (E) | | | | | | | | | | | | | | 20 |
| Maleimide monomer unit content | | | parts by mass | 16.5 | 19.3 | 15.6 | 18.2 | 22.0 | 20.8 | 22.0 | 9.2 | 8.7 | 0.0 | 16.1 | 16.1 |
| Evaluation | Paintability | Test piece (a-1) | — | Δ | Δ | Δ~◯ | Δ | ◯ | ◯ | ◯ | ⊚ | ⊚ | ⊚ | ⊚ | ⊚ |
| Results | (Popping | Test piece (a-2) | — | X | X | X | X | Δ | Δ | Δ | ◯ | ◯ | ◯ | ⊚ | ⊚ |
| | points | | | | | | | | | | | | | | |
| | Evaluation) | | | | | | | | | | | | | | |

| | | | | | | | | | | | | | |
|---|---|---|---|---|---|---|---|---|---|---|---|---|---|
| HDT | ° C. | 97 | 100 | 96 | 99 | 103 | 102 | 103 | 89 | 88 | 82 | 80 | 80 |
| MVR | cm³/10 minutes | 18 | 16 | 18 | 17 | 12 | 12 | 7 | 17 | 18 | 18 | 30 | 20 |
| Charpy Impact Strength | kJ/m² | 13 | 11 | 13 | 9 | 8 | 8 | 5 | 9 | 10 | 10 | 2 | 7 |
| Molding Appearance | — | ◯ | ◯ | ◯ | ◯ | ◯ | ◯ | ◯ | ◯ | ◯ | ◯ | X | X |
| Vibration Fatigue | times | 3.3 × | 3.0 × | 3.2 × | 3.1 × | 3.0 × | 3.0 × | 3.1 × | 1.9 × | 1.7 × | 2.5 × | 1.5 × | 1.5 × |
| | | 10⁴ | 10⁴ | 10⁴ | 10⁴ | 10⁴ | 10⁴ | 10⁴ | 10⁴ | 10⁴ | 10³ | 10³ | 10³ |

### [Summary of Results]

From the above evaluation results, Examples 1 to 29, which correspond to the thermoplastic resin compositions of the present invention, had excellent paintability, heat resistance, fluidity, impact resistance, and appearance, and were also sufficiently excellent in fatigue tests.

On the other hand, in Comparative Examples 1 to 4, since the component (B) did not contain acrylonitrile, the paintability was especially poor at 220° C. where molding stress strain occurs. Furthermore, the fatigue properties at high temperatures tended to be inferior compared to Examples 1 to 4.

In Comparative Examples 5 and 6, the component (B) did not contain acrylonitrile, but since the component (D) was included, the paintability tended to be improved. However, the fatigue properties tend to be inferior to Comparative Examples 1 to 4.

In Comparative Example 7, the amount of acrylonitrile of the component (B) was higher than the specified range of the present invention, so the fluidity was poor and the fatigue properties also tended to be poor.

In Comparative Examples 8, 9, and 10, the maleimide monomer unit content was lower than the specified range of the present invention, therefore the heat resistance was greatly inferior, and the vibration fatigue tests under high temperature conditions was particularly inferior.

Reference Examples 1 and 2 were cases in which the components (D) and (E) were blended in excess, and the impact resistance, heat resistance, and molded appearance were poor.

Although the present invention has been described in detail by way of the specific modes, it is apparent for those skilled in the art that various changes can be made without departing from the spirit and scope of the present invention.

The present application is based on Japanese Patent Application No. 2022-037315 filed on May 10, 2022, the entire contents of which are incorporated herein by reference.

1. A thermoplastic resin composition comprising:
10 to 50 parts by mass of a rubber-containing graft copolymer (A) obtained by graft polymerizing a vinyl monomer mixture (a2) containing a vinyl cyanide monomer and an aromatic vinyl monomer in the presence of a rubbery polymer (a1);
5 to 90 parts by mass of a vinyl cyanide-maleimide copolymer (B) obtained by copolymerizing 5 to 30% by mass of a vinyl cyanide monomer (b1), 20 to 60% by mass of a maleimide monomer (b2), and 10 to 75% by mass of another vinyl monomer (b3) copolymerizable with these (where a total of (b1), (b2), and (b3) is 100% by mass); and
0 to 45 parts by mass of a vinyl cyanide-aromatic vinyl copolymer (C) obtained by copolymerizing a vinyl monomer mixture (c1) containing a vinyl cyanide monomer and an aromatic vinyl monomer,
a total of the rubber-containing graft copolymer (A), the vinyl cyanide-maleimide copolymer (B), and the vinyl cyanide-aromatic vinyl copolymer (C) being 100 parts by mass,
wherein the content of the maleimide monomer unit in the thermoplastic resin composition is 10 to 45 parts by mass based on 100 parts by mass of the total of the rubber-containing graft copolymer (A), the vinyl cyanide-maleimide copolymer (B), and the vinyl cyanide-aromatic vinyl copolymer (C).

2. The thermoplastic resin composition according to claim 1, further comprising 0.1 to 15 parts by mass of an olefin resin (D) based on 100 parts by mass of the total of the rubber-containing graft copolymer (A), the vinyl cyanide-maleimide copolymer (B), and the vinyl cyanide-aromatic vinyl copolymer (C).

3. The thermoplastic resin composition according to claim 1, further comprising 0.1 to 15 parts by mass of an ethylene-(meth)acrylic acid ester-carbon monoxide copolymer (E) based on 100 parts by mass of the total of the rubber-containing graft copolymer (A), the vinyl cyanide-maleimide copolymer (B), and the vinyl cyanide-aromatic vinyl copolymer (C).

4. The thermoplastic resin composition according to claim 1, wherein the vinyl monomer (b3) is at least one selected from the group consisting of aromatic vinyl monomers, unsaturated carboxylic acid ester monomers, unsaturated dicarboxylic acids, unsaturated dicarboxylic acid anhydrides, and unsaturated amides.

5. A thermoplastic resin molded article produced by molding the thermoplastic resin composition according to claim 1.

6. A painted part obtained by coating the thermoplastic resin molded article according to claim 5.
